(19) United States
(12) Patent Application Publication
(10) Pub. No.: US 2016/0061929 A1
(43) Pub. Date: Mar. 3, 2016

(54) AN AUTONOMOUS SURVEILLANCE SYSTEM FOR BLIND SOURCES LOCALIZATION AND SEPARATION

(71) Applicant: Wayne State University, Detroit, MI (US)

(72) Inventor: Sean F. Wu, Troy, MI (US)

(21) Appl. No.: 14/787,907

(22) PCT Filed: Apr. 29, 2014
(86) PCT No.: PCT/US2014/035865

§ 371 Date: Oct. 29, 2015

Related U.S. Application Data
(60) Provisional application No. 61/817,041, filed on Apr. 29, 2013.

(51) Int. Cl. G01S 3/80

(52) U.S. Cl. CPC G01S 3/8006

(57) ABSTRACT

A sound monitoring system provides autonomous and silent)) surveillance to monitor sound sources stationary or moving in 3D space and a blind separation of target acoustic signals. The underlying principle of this technology is a hybrid approach that uses: 1) passive sonic detection and ranging method that consists of iterative triangulation and redundant checking to locate the Cartesian coordinates of arbitrary sound sources in 3D space, 2) advanced signal processing to sanitize the measured data and enhance signal to noise ratio, and 3) short-time source localization and separation to extract the target acoustic signals from the directly measured mixed ones.

### RELATED APPLICATIONS

This disclosure claims priority to U.S. Provisional Application No. 61/817041, which was filed on Apr. 29, 2013 and is incorporated herein by reference.

### BACKGROUND OF THE INVENTION

In practice it is often desirable to be able to not only track and trace sound sources moving in 3D space, but also separate signals without any prior knowledge of the characteristics of the sources and those of the surrounding environment. Such processes are known as blind source localization and blind source separation. Needless to say, these are very challenging tasks because each environment can be very different that produce different multipath of sound waves traveling in space and different sound reflections, diffractions, and reverberations resulting from a number of unspecified obstacles in unspecified space with unknown dimensions, sizes, and material properties of reflecting surfaces.

The existing methods for locating sound sources include triangulation, beamforming, time reversal, just to name a few. Triangulation is suitable for locating impulsive sound sources in free space with negligible ambient noise. Beamforming can determine the bearing of the incident sound wave, but not the range of the source. The spatial resolution of beamforming is no better than the wavelength of the sound emitted from a source. Time reversal relies on scanning over the entire space based on the time-reversed signals measured at individual sensors, which can be time consuming.

Note that several methods have been developed to address the issue of blind source separation (BSS). BSS takes the mixed signals and separates the constituent components without the need to know anything about sources, their locations and relative contributions toward the input data measured by microphones. Several algorithms have been developed for BSS, including the principal component analysis (PCA), independent component analysis (ICA), non-negative matrix factorization (NMF), stationary subspace analysis (SSA), etc. However, these algorithms are based on some specified properties of the signals. For example, sources signals are non-Gaussian, uncorrelated and statistically independent; sensors are in different positions so each sensor receives a linear mixture of signals with different mixture coefficients; etc. As such, BSS is suitable for certain types of mixtures of signals, and none of them can handle arbitrarily mixed signals.

### SUMMARY

Recently, a new technology known as passive Sonic Detection And Ranging (SODAR) has been developed for locating sound sources that emit arbitrarily time-dependent signals in real time in a typical environment encountered in practice such as semi-free/semi-reverberant fields that involve a large number of unspecified reflected and diffracted sound waves. Unlike beamforming, this passive SODAR does not need a large number of microphones and prior knowledge of the relative orientation of the array with respect to the target sources. Nor does it require the information of the number of microphones, geometry, dimensions, and material properties of obstacles and reflecting surfaces, etc. of a test site. In other words, sound sources can be located completely blindly. Moreover, this passive SODAR requires much less number of microphones than beamforming and time reversal do.

The present system and method combine passive SODAR with blind sources separation based on short-time source localization. This is accomplished by dividing the measured data to very short segments, using passive SODAR to locate sound sources in each frequency band, and linking the located sound source to the corresponding time-domain signal. Note that passive SODAR can only locate the most dominant sound source in any specified frequency band for any particular time instance. Therefore, this approach is known as short-time Source Localization And Separation (SLAS). Since SODAR is built on a comprehensive signal processing and source localization methodologies together with an optimization process, it may be used to locate sound sources emitting arbitrary time-domain signals in a highly non-ideal environment that involves unspecified reflected and diffracted sound waves from unspecified obstacles and surfaces.

### BRIEF DESCRIPTION OF THE DRAWINGS

FIG. 1 is a schematic of one example system according to one embodiment of the present invention.

FIG. 2 is a flowchart of one possible method according to the present invention.

### DETAILED DESCRIPTION OF A PREFERRED EMBODIMENT

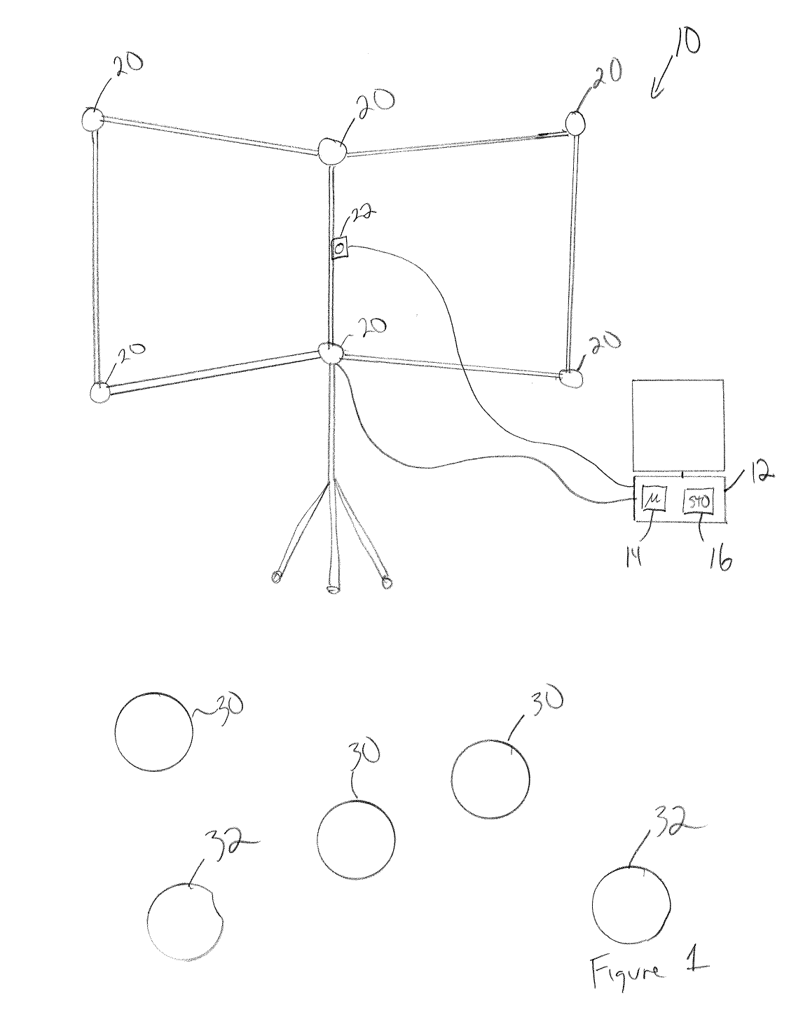

Referring to FIG. 1, a sound monitoring system 10 according to the present invention includes a computer 12 having a processor 14 and storage 16 including memory and mass storage, such as magnetic, electronic and/or optical storage. One or more transducers 20, such as microphones, probes and other sensors, may be used to measure sound pressure (or other physical signals) and send signals to the computer 12 indicating the capture of sound pressure (or other physical signals) at the location of the transducers 20. In this example, six microphones 20 are used. A digital camera 22 may also be mounted near the microphones 20 and connected to the computer 12, so that the sources of the sound can be viewed. The computer 12 may include or be accompanied by a data acquisition module receiving signals from the transducers 20.

The sound monitoring system 10 of the present invention uses an algorithm described below to extract information from one or more target sources 30. The algorithm is stored in storage 16 and executed by the processor 14 in the computer 12. The computer 12 is programmed to perform the outlined steps using the algorithms described herein and any necessary functions. The location, number and nature of the sources 30 and background noise sources 32 may be unknown. The transducers 20 or sensors are suitable for the type of target signals being measured, such as microphones, vibration sensors, etc.

In passive SODAR it is assumed that sound waves are emitted by point sources in free space and their amplitudes obey the spherical spreading law,

$$p ( r , θ , φ ; t ) = \frac{A ( r , θ , φ ; t )}{r} , \qquad ( 1 )$$

where A indicates the amplitude of the acoustic pressure at a measurement point (r, θ, φ). The goal is to determine the coordinates of a source using a minimal number of sensors in real time, not the amplitude. Note that there are no restrictions whatsoever on source types and frequency ranges.

Suppose that the distance between a sound source and the i^{th} sensor is rᵢ, that between a sound source and the j^{th} sensor is rⱼ, and time difference of arrival (TDOA) between these sensors is Δt_{i,j}. Then the distance rⱼ can be written as the sum of rᵢ and the distance traveled by the sound wave from the i^{th} to i^{th} sensors:

rⱼ=rᵢ+cΔt_{i,j}, i,j=1, 2, . . . , M, i≠j; (2)

where c is the speed of sound that can be obtained using the Laplace's adiabatic assumption for an ideal gas and temperature at a test site, and M is the total number of sensors. Solving the set of simultaneous equations (2) in terms of the Cartesian coordinates leads to

\sqrt{(x−xⱼ)²+(y−yⱼ)²+(z−zⱼ)²}=\sqrt{(x−xᵢ)²+(y−yᵢ)²+(z−zᵢ)²}+(cΔt_{i,j}), (3)

where i, j=1, 2, . . . , M, i≠j; (x, y, z) are the Cartesian coordinates of an unknown source, (xᵢ, yᵢ, zᵢ), i=1 to M, and (xⱼ, yⱼ, zⱼ), j=1 to M, are the coordinates of the measurement sensors specified in the setup, and Δt_{i,j} implies the TDOA obtained by taking a cross correlation of the signals that are measured by the i^{th} and i^{th} sensors. The explicit solution to Eq. (3) is given in U.S. Patent Publication 20120093339, Ser. No. 13/265,983, filed Dec. 26, 2011, hereby incorporated by reference in its entirety, and is omitted here for brevity. Note that there are two solutions to Eq. (3), and one of them is false and must be discarded.

Passive SODAR can only locate the most dominant sound source in a specific frequency band at a specific time instance. Since in general the sound signals are arbitrary, the most dominant signals in different frequency bands at different time instances may be different. This offers an opportunity for us to separate individual source signals by dividing the time-domain signals into many short time segments. In general, the shorter the time segments are, the more accurately the variations in the time-domain signals can be captured, but the worse the frequency resolution in source separation becomes. This phenomenon is exactly the same as that in short-time Fourier transform (STFT). Accordingly, a compromise must be made to ensure an optimal resolution for both time and frequency in sources localization and separation. For example, time-domain signals may be divided into a uniform segment of Δt=0.1 (sec), STFT is performed on each time segment, and the resultant spectrum is expressed in the standard octave bands.

Theoretically, one may use a much finer resolution in frequency to locate and separate source signals. For example, for this short time segment Δt=0.1, one can get a frequency resolution of Δf≧1/Δt=5 Hz. However, this will substantially increase the computation time because source localization must be carried out over every 5 Hz for every 0.1 second of input data. For most applications such a fine resolution in frequency is unnecessary. Therefore, for example, the standard octave bands over the frequency range of 20-20,000 Hz can be used. Thus, for example, the spectrogram for the directly measured mixed signals in 0.1 second increment over 20 to 2,500 Hz frequency range.

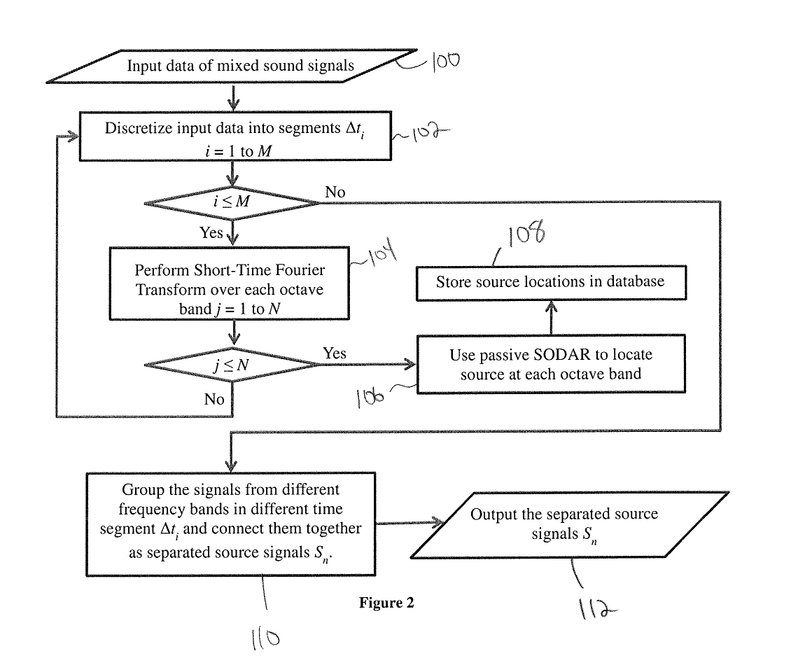

FIG. 2 shows the flow chart of this short-time SLAS algorithm. In step 100, the mixed sounds signals are input. In step 102, the input data are discretized into a uniform short time segment Δt and the STFT is carried out for each Δt in step 104. The resultant spectrum is expressed in the standard octave bands and passive SODAR is used to determine the locations of the dominant source in each band in step 106. The source locations 108 are stored in step 108 (such as in storage 16 of computer 12 of FIG. 1). These steps are repeated until source localizations in all frequency bands for all time segments are completed. Next, in step 110, all signals in various frequency bands at different time segments that correspond to the same source are strung together, which represent the separated signals. These separated signals may be played back in which the interfering signals including background noise are minimized. The separated source signals may be output in step 112.

The short-time SLAS algorithm was validated experimentally. In particular, measurements were conducted in a highly non-ideal but frequently encountered environment in practice such as a laboratory. There was constant random noise produced by heating, ventilation, and air-conditioning system, people talking and walking in the background, etc. Moreover, there were unspecified numbers of multi-paths for the reflected and diffracted sound waves from unspecified obstacles and surfaces, making it impossible to find a closed-form solution to describe the interior sound field.

FIG. 1 displays the array of microphones 20 used in this study to locate the sound sources 30 that emitted arbitrarily time-dependent acoustic signals. This array consisted of six B&K ¼-in condenser microphones 20, Type 4935, which were separated by a distance of 0.8m and are mounted on two planes intersected at ∠120°. An NI PXI-4472 high-accuracy data acquisition module (not shown) in an NI PXI-1033 Chassis with a sampling rate of 51.2 kHz, a thermometer (not shown) to monitor temperatures, a web camera 22 to facilitate the viewing of the surrounding objects and source localization results, and a computer 12 to control data acquisition and post processing. The microphone 20 array was installed on a tripod and mounted on a trolley for easy transportation.

It is emphasized that throughout this study, no frequency range was designated in data acquisition and source localization. Also, no prior information regarding the characteristics of the target sources was utilized. In other words, the source localization and separation were conducted in a completely blind manner.

Different types of signals such as transient, continuous, impulsive, narrow- and broadband sounds were used in this study. For brevity, only one set of source localization and separation is presented here. In this test, the dominant sound signals 30 consisted of talking of a man, background music playing, and random background noise 32 in a typical laboratory, where there were many furniture, tables, chairs, etc. that caused a large number of unspecified reflected, diffracted and reverberated sound waves (see FIG. 1).

The directly measured (mixed) signals were taken as input to passive SODAR algorithm to determine the respective sound source locations, and simultaneously to short-time SLAS algorithm to extract the signals emitted by various sources from the mixed signals and store them in separate wave files. These separated files represent the extracted signals and can be played back and compared with the original directly measured data.

The camera 22 can be used to generate a digital picture on which the locations of the sound sources 30 can be identified by the computer, as identified by passive SODAR. Note that in theory the passive SODAR can locate as many numbers of sources as those of frequency bands simultaneously, provided that there are as many numbers of dominant sources as those of the frequency bands. Note that there is no need to use the standard octave bands. Any user-defined bands can be used in passive SODAR to locate sound sources during any time instance, so long as the time and frequency resolution requirement for the STFT is satisfied.

Note that throughout the experimental validations, no prior information of the characteristics of target sources 30, their respective locations, etc. was used in source localization and separation. The mixed signals were measured directly and source localization and separation were carried out subsequently.

Note that experimental results have demonstrated that the finer the discretization in time record Δt is, the better the source separation results become Likewise, the finer the discretization in frequency bands is, the better and more complete the separated signals may be. This is because as Δt reduces, the distinctions between individual acoustic signals become more apparent, making it easier for the source separation. Likewise, further reducing the bandwidth in frequencies will greatly enhance sources separations. In this study we have selected the standard octave bands for frequencies, but much narrower frequency bands would be preferred.

The passive SODAR and short-time SLAS algorithms were used to perform completely blind sources localization and separation in a highly non-ideal environment. Test results indicate that the proposed approach seem to work. The accuracy in blind source separations can be further improved by decreasing the time segment Δt and using a much finer user-defined frequency band than the standard octave bands

In accordance with the provisions of the patent statutes and jurisprudence, exemplary configurations described above are considered to represent a preferred embodiment of the invention. However, it should be noted that the invention can be practiced other than as specifically illustrated and described without departing from its spirit or scope.

What is claimed is:

1. A method for monitoring sound including the steps of:
a) measuring sound from a plurality of sound sources at a plurality of locations;
b) dividing the sound measurements into time segments; and
c) using a computer to locate the sound sources within a plurality of frequency bands in each of the plurality of time segments.

2. The method of claim 1 further including the step of combining signals in the plurality of frequency bands and in the plurality time signals for each of the plurality of sound sources.

3. The method of claim 2 further including the step of: using the computer to perform iterative triangulation and redundant checking to locate the Cartesian coordinates of the sound sources in 3D space.

4. The method of claim 3 further including the step of: the computer performing short-time source localization and separation to extract acoustic signals from the sound sources from the directly measured mixed ones.

5. The method of claim 1 wherein the number of sound sources, locations of the sound sources and frequencies of the sounds sources are unknown.

6. A system for monitoring sound comprising:
a plurality of transducers measuring sound at a plurality of locations; and
a computer receiving signals indicating the sound measurements from the plurality of transducers, the computer programmed to divide the sound measurements into time segments, the computer programmed to locate the sound sources within a plurality of frequency bands in each of the plurality of time segments.

7. The system of claim 6 wherein the computer is further programmed to combine signals in the plurality of frequency bands and in the plurality time signals for each of the plurality of sound sources.

8. The system of claim 6 where the computer is programmed to perform iterative triangulation and redundant checking to locate the Cartesian coordinates of the sound sources in 3D space.

9. The system of claim 6 wherein the computer is programmed to perform short-time source localization and separation to extract acoustic signals from the sound sources from the signals indicating the sound measurements.

10. The system of claim 6 wherein the number of sound sources, locations of the sound sources and frequencies of the sounds sources are unknown.
